(19) United States
(12) Patent Application Publication
(10) Pub. No.: US 2008/0158272 A1
(43) Pub. Date: Jul. 3, 2008

(54) Recording apparatus and recording method

(75) Inventors: Yoichiro Shimizu, Kasugai-shi (JP); Takahiro Yamada, Toyoake-shi (JP); Naoya Okazaki, Gifu-shi (JP); Masaru Someya, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 12/005,759

(22) Filed: Dec. 28, 2007

(30) Foreign Application Priority Data
Dec. 29, 2006 (JP) 2006-356793

(51) Int. Cl. B41J 2/195

(52) U.S. Cl. 347/7

(57) ABSTRACT

A recording apparatus includes a recording head which discharges an ink onto a recording medium to form an image thereon; a sub tank which is movable together with the recording head and which stores the ink to be supplied to the recording head; an ink supplement section which supplements the sub tank with the ink; and a controller which controls the ink supplement section. The controller controls the ink supplement section to supplement the sub tank with the ink when a residual-ink amount of the ink contained in the sub tank is not more than a threshold value, and the controller is capable of changing the threshold value. Therefore, the number of times of the ink supplement operation is reduced as much as possible by flexibly changing the threshold value depending on the situation while avoiding the discontinuity of the recording operation.

### CROSS REFERENCE TO RELATED APPLICATION

The present application claims priority from Japanese Patent Application No. 2006-356793, filed on Dec. 29, 2006, the disclosure of which is incorporated herein by reference in its entirety.

### BACKGROUND OF THE INVENTION

1. Field of the Invention

The present invention relates to a recording apparatus for forming an image by discharging an ink onto a recording medium, and a recording method based on the use of the recording apparatus. In particular, the present invention relates to a recording apparatus of the type wherein a sub tank, which is movable together with a recording head, is supplemented with the ink at a predetermined timing, and a recording method based on the use of the recording apparatus.

2. Description of the Related Art

For example, the station supply system (also referred to as “on-demand system”) is known as one of the ink supply systems for the recording apparatus such as the ink-jet printer. As described, for example, in U.S. Pat. No. 6,447,084 (corresponding to Japanese Patent Application Laid-open No. 2000-334976), the recording apparatus based on this system is provided with a sub tank which is movable together with a recording head, and an ink supplement section which supplements the sub tank with the ink. The ink supplement section is operated at a predetermined timing to supplement the sub tank with the ink.

In U.S. Pat. No. 6,447,084, in order to avoid such a situation that the recording operation is discontinued to supplement the ink during the recording operation on one sheet of the recording medium, the ink amount, which is minimally required for the completion of the recording on one sheet of the recording medium, is preset or defined as a threshold value. If it is judged that the ink residual amount in the sub tank is not more than the threshold value, the ink supplement is executed prior to the start of the recording.

The images, which are to be formed by the recording apparatus, involve various image quality modes and various image types which require mutually different ink amounts to complete the recording for on one sheet of the recording medium. In the case of the recording apparatus disclosed in Japanese Patent Application Laid-open No. 2000-334976, if a low ink residual amount is preset as the basis of the threshold value to find out the timing for the ink supplement, for example, there is a possibility that the ink supplement may be required during the recording operation in the high image quality mode. Therefore, in order to appropriately avoid the discontinuity of the recording operation caused by the ink supplement, the threshold value is inevitably determined while assuming the recording of the image in which the largest amount of the ink is consumed, of those of the image quality modes and the image types.

However, if the threshold value is determined as described above, when it is intended to execute the recording in which the ink consumption amount is actually relatively small and even when the ink residual amount has a margin to such an extent that it is unnecessary to supplement the ink, the ink supplement operation is executed in some cases. As a result, there is a possibility that the ink supplement operation may be frequently executed during the period in which the image is recorded on a plurality of sheets of the recording medium. The recording waiting time is prolonged, and a disagreeable impression arises in the user. Such a situation may commonly occur in the recording apparatus of such a type that the sub tank, which is movable together with the recording head, is supplemented with the ink, without being limited to only the station supply system.

### SUMMARY OF THE INVENTION

In view of the above, an object of the present invention is to provide a recording apparatus which makes it possible to reduce the recording waiting time by suppressing the frequent occurrence of the ink supplement operation while avoiding the discontinuity of the recording operation caused by the ink supplement.

According to a first aspect of the present invention, there is provided a recording apparatus including: a recording head which discharges an ink onto a recording medium to form an image thereon; a sub tank which is movable together with the recording head and which stores the ink to be supplied to the recording head; an ink supplement section which supplements the sub tank with the ink; and a controller which controls the ink supplement section, wherein the controller controls the ink supplement section to supplement the sub tank with the ink when a residual-ink amount of the ink contained in the sub tank is not more than a threshold value, and the controller is capable of changing the threshold value.

According to the first aspect of the present invention, the ink supplement is performed when the residual-ink amount of the ink contained in the sub tank is not more than the threshold value, and thus the recording operation is prevented from being discontinued, while the number of times of the ink supplement operation is reduced as much as possible by flexibly changing the threshold value depending on the situation. It is possible to reduce the recording waiting time which would be otherwise required due to the ink supplement.

In the recording apparatus of the present invention, the controller may be capable of changing the threshold value based on an image type of the image to be formed on the recording medium. In this case, when the recording operation is performed for various image types in which the ink consumption amount differs, the ink supplement operation can be executed based on the threshold value according to the image type. It is possible to appropriately reduce the number of times of the ink supplement operation.

In the recording apparatus of the present invention, the image type may include a text type for mainly recording letters and symbols, a paint graph type for performing record of an image including an area densely recorded with the ink without leaving any space, and a photograph type for recording a photograph image. In this case, when the recording operation is performed in accordance with at least the text type, the paint graph type, and the photograph type, the ink supplement operation can be executed based on the threshold value according to each of the image types. The text type herein means the image type in which letters and symbols are mainly recorded as described above, and the image is mainly composed of sentences and numerical expressions. The paint graph type corresponds to the image type to be adopted, for example, when a poster of an abstract picture or painting is recorded. The paint graph type means the image type in which all of the dots for forming the image have relatively high gradations (i.e., a relatively large amount of ink is required to form the dot). Further, the photograph type corresponds to the image type to be adopted when the photograph is recorded. The photograph type means the image type in which the gradations of the respective dots for forming the image have the difference in level (i.e., the concentration differs between the respective dots).

In the recording apparatus of the present invention, the threshold value may be greater in an order of the paint graph type, the photograph type, and the text type. In this case, the threshold value can be preset or defined appropriately depending on each of the image types.

In the recording apparatus of the present invention, the controller may be capable of changing the threshold value based on an image quality mode of the image to be formed on the recording medium. In this case, when the recording operation is performed in various image quality modes in which the ink consumption amount differs, the ink supplement operation can be executed based on the threshold value corresponding to the image quality mode. It is possible to appropriately reduce the number of times of the ink supplement operation.

In the recording apparatus of the present invention, when a same image is recorded on a plurality of sheets of the recording medium respectively, the controller may determine, based on an ink amount used in recording on a first sheet among the plurality of sheets of the recording medium, a threshold value for recording on a second sheet of the recording medium and thereafter. In this case, when the same image is recorded on a plurality of sheets of the recording medium respectively, the threshold value can be defined more accurately when the recording is performed on the second sheet of the recording medium and thereafter.

In the recording apparatus of the present invention, when the same image is recorded on the plurality of sheets of the recording medium respectively, the controller may control, before performing recording on the first sheet of the recording medium, the ink supplement section to supplement the sub tank with the ink until the residual-ink amount in the sub tank is maximized. In this case, even when the correct consumption amount of the ink required for the recording on a first sheet of the recording medium is not definite, there is a margin while the residual amount of the ink contained in the sub tank is previously maximized. Therefore, the ink is not exhausted during the recording operation on the first sheet of the recording medium.

In the recording apparatus of the present invention, when the same image is recorded on a plurality of sheets of the recording medium respectively and when the residual-ink amount in the sub tank is not more than the threshold value before performing recording on a first sheet of the recording medium, the controller may control the ink supplement section to supplement the sub tank with the ink; and after completing the recording on the first sheet of the recording medium, the controller may calculate a second threshold value based on an ink-amount of the ink used for the recording of the first sheet; and may determine the second threshold value as a new threshold value for recording on a second sheet of the recording medium and thereafter. In this case, the second threshold value can be preset or defined highly accurately when the recording is performed on the second sheet of the recording medium and thereafter. Further, when the recording is initially performed on the first sheet of the recording medium, it is also possible to judge whether or not the ink supplement operation is required based on the first threshold value appropriate thereto.

In the recording apparatus of the present invention, the controller may determine the threshold value depending on at least the image type. In this case, when the recording operation is performed for various image types in which the ink consumption amount differs, the ink supplement operation can be performed based on the threshold value corresponding to at least the image type, in the same manner as explained above. It is possible to appropriately reduce the number of times of the ink supplement operation.

In the recording apparatus of the present invention, the threshold value may be greater than the value calculated as the second threshold value. In this case, it is possible to avoid the occurrence of the exhaustion of the ink during the recording on a first sheet of the recording medium. It is possible to reliably obtain the amount of the ink consumed by the recording on the first sheet of the recording medium.

The recording apparatus of the present invention may further include a scanner which reads an image recorded on the recording medium, and when the image which is read by the scanner is to be recorded on the recording medium and when the sub tank is supplemented with the ink, the controller may control the ink supplement section to supplement the sub tank with the ink during a period in which the scanner reads the image. In this case, when the ink supplement is required upon the recording on the recording medium in the recording apparatus having so-called scanner, it is possible to complete the ink supplement during the reading (scanning) of the image performed by the scanner. Therefore, the ink supplement can be performed efficiently in a temporal viewpoint.

The recording apparatus of the present invention may further comprise a scanner which reads an image recorded on a recording medium, and when the image which is read by the scanner is to be recorded on each of the plurality of sheets of the recording medium and when the sub tank is to be supplemented with the ink prior to the recording on the first sheet of the recording medium, the controller may control the ink supplement section to supplement the sub tank with the ink during a period in which the scanner reads the image. In this case, when the same scan image is recorded on a plurality of sheets of the recording medium respectively, the ink can be supplemented during the scanning prior to the recording on the first sheet of the recording medium. Therefore, it is possible to avoid the occurrence of the ink exhaustion during the recording on the first sheet of the recording medium. Further, it is also possible to perform the ink supplement efficiently during the scanning.

In the recording apparatus of the present invention, the controller may control the ink supplement section to communicate the ink supplement section with the sub tank and then to recover the residual ink in the sub tank to the ink supplement section, and may cause the ink to be supplemented from the ink supplement section to the sub tank. In this case, it is possible to realize the prevention of the discontinuity of the recording operation caused by the ink supplement as described above and the suppression of the frequent occurrence of the ink supplement operation, even in the case of the recording apparatus based on the so-called station supply system as well.

According to a second aspect of the present invention, there is provided a recording method for using a recording apparatus provided with a recording head which discharges an ink onto a recording medium to form an image, a sub tank which is movable together with the recording head and which stores the ink to be supplied to the recording head, and an ink supplement section which supplies the ink to the sub tank, the recording method comprising: receiving a recording instruction; determining a threshold value based on the recording instruction; detecting a residual-ink amount of the ink contained in the sub tank; recovering the ink contained in the sub tank to the ink supplement section when the residual-ink amount in the sub tank is not more than the threshold value; supplementing the sub tank with the ink from the ink supplement section until the residual-ink amount in the sub tank is greater than the threshold value; and recording the image by discharging the ink supplemented in the sub tank.

According to the second aspect of the present invention, the discontinuity of the recording operation is avoided by performing the ink supplement when the residual amount of the ink contained in the sub tank is not more than the threshold value, while the number of times of the ink supplement operation is reduced as much as possible by determining the threshold value depending on the recording instruction. It is possible to reduce the recording waiting time which would be otherwise required due to the ink supplement.

In the recording method of the present invention, the threshold value may be an amount of the ink required for recording on one sheet of the recording medium.

In the recording method of the present invention, when the residual-ink amount in the sub tank is not more than the threshold value, then the ink contained in the sub tank may be recovered to the ink supplement section, and the sub tank may be thereafter supplemented with the ink from the ink supplement section to be fully filled with the ink.

In the recording method of the present invention, when the residual-ink amount in the sub tank is greater than the threshold value, the image may be recorded based on the recording instruction.

In the recording method of the present invention, the recording instruction may include an information that including a type of the image to be recorded is a text type for mainly recording letters and symbols, a paint graph type for performing a record of an image including an area densely recorded with the ink without leaving any space, or a photograph type for recording a photograph image; and the threshold value may be determined based on the information about the type of the image included in the recording instruction.

In the recording method of the present invention, the recording instruction may further include another image-quality information about an image quality mode of the image to be recorded; and the threshold value may be determined based on the information about the image quality mode included in the recording instruction.

### BRIEF DESCRIPTION OF THE DRAWINGS

FIG. 1 shows a perspective view illustrating a structural appearance of a recording apparatus according to an embodiment of the present invention.

FIG. 2 shows a schematic sectional view illustrating an arrangement of a printer provided for the recording apparatus shown in FIG. 1.

FIG. 3 shows a plan view illustrating main components of the printer shown in FIG. 2, which depicts a state in which an image-recording unit is positioned at a predetermined position for performing the ink supplement.

FIG. 4 shows a sectional view principally illustrating the arrangement of the image-recording unit and an ink supplement section, which depicts the arrangement as obtained by cutting a part of the printer shown in FIG. 3 along a cutting line IV-IV.

FIG. 5 shows a block diagram illustrating the function possessed by the recording apparatus shown in FIG. 1.

FIG. 6 shows a flow chart illustrating the operation of the recording apparatus in relation to the ink supplement process.

FIG. 7 schematically shows the state change of the image-recording unit and an ink supplement section during the ink supplement process, wherein FIG. 7A shows a state in which a cartridge and a sub tank are communicated with each other before the ink supplement, FIG. 7B shows a state in which the ink is once recovered from the sub tank, and FIG. 7C shows a state in which the sub tank is supplemented with the ink.

FIG. 8 shows a table illustrating the relationship between the image type, the image quality mode, and the threshold value (first threshold value) preset in the recording apparatus.

FIGS. 9A and 9B show a flow chart illustrating the process procedure for determining the threshold value to be performed by the controller.

FIGS. 10A and 10B show a flow chart illustrating the copy process procedure to be performed by the controller.

FIG. 11 shows a flow chart illustrating the execution timing for the ink supplement process in the copy process for recording the scanned image on a plurality of sheets of recording paper.

### DESCRIPTION OF THE PREFERRED EMBODIMENTS

An explanation will be specifically made below with reference to the drawings about a recording apparatus according to an embodiment of the present invention.

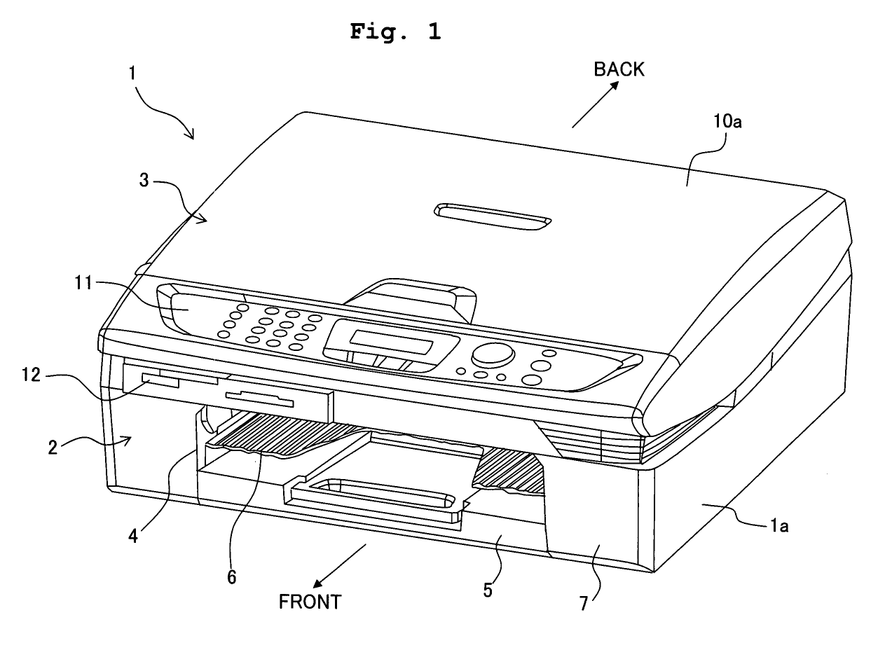

FIG. 1 shows a perspective view illustrating a structural appearance of the recording apparatus 1 according to the embodiment of the present invention. In this embodiment, the so-called multifunction machine is depicted as the recording apparatus 1. As shown in FIG. 1, the recording apparatus 1 is the multi function device provided with a printer 2 for recording the image in accordance with the ink-jet system at a lower portion of a box-shaped casing 1a, and a scanner 3 at an upper portion of the casing 1a. The recording apparatus 1 has the printer function, the scanner function, the copy function, and the facsimile function.

The recording apparatus 1 is connected to an external information device such as a personal computer so that the image, which includes, for example, the text, the photograph, and the paint graph, is recorded on the recording paper as the recording medium based on the data transmitted from the computer or the like. When a digital camera or the like is connected to the recording apparatus 1, the photograph is recorded on the recording paper on the basis of the data outputted from the digital camera or the like. Further, when various storage media such as memory cards are inserted, the image is recorded on the recording paper on the basis of the data recorded on the storage medium.

As shown in FIG. 1, the recording apparatus 1 has an opening 4 which is disposed on the front surface (front side) of the printer 2 arranged at the lower portion. A paper feed tray 5 disposed on the lower side and a paper discharge tray 6 disposed on the upper side are provided in a two-stage form at the inside of the opening 4. A plurality of sheets of the recording paper can be accommodated in the paper feed tray 5. For example, a plurality of sheets of the recording paper, which have various sizes of not more than the A4 size, can be accommodated.

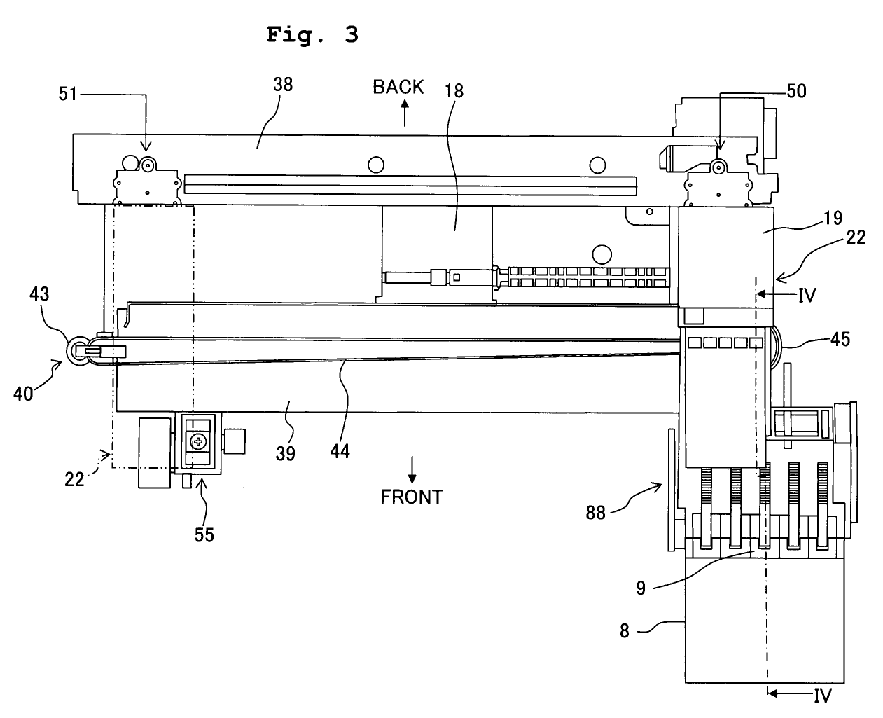

A door 7 is provided openably/closably at a lower-right portion on the front surface of the printer 2. A main tank-carrying section 8 (see FIG. 3) is provided at the inside of the door 7. Therefore, when the door 7 is opened, the main tank-carrying section 8 is exposed on the front surface side, and main tanks (ink cartridges) 9 (see FIG. 3) can be attached/detached. Accommodating chambers, which correspond to the ink colors to be used, are provided for the main tank-carrying section 8. In the case of this printer 2, those used are color inks of five colors, i.e., cyan (C), magenta (M), yellow (Y), and photo black (PBk) as dye inks and black (Bk) as pigment ink. Therefore, the five accommodating chambers are comparted in the main tank-carrying section 8. The main tanks 9, which store the inks of the respective colors of cyan (C), magenta (M), yellow (Y), photo black (PBk), and black (Bk), are accommodated in the respective accommodating chambers.

The scanner 3, which is provided at the upper portion of the recording apparatus 1, is a so-called flat bed scanner. That is, as shown in FIG. 1, a manuscript cover 10, which is provided openably/closably as a top plate of the recording apparatus 1, is provided on the upper surface of the recording apparatus 1. For example, a platen glass on which the manuscript is placed and an image sensor which reads the image of the manuscript are arranged under the manuscript cover 10.

An operation panel 11, which is used to operate the printer 2 and the scanner 3, is provided at a front upper portion of the recording apparatus 1. The operation panel 11 is composed of various operation buttons and a liquid crystal display. The recording apparatus 1 is operated on the basis of the instruction outputted from the operation panel 11 as a result of the operation of the operation panel 11 by a user. When the recording apparatus 1 is connected to the external computer, the recording apparatus 1 is operated on the basis of the instruction transmitted from the computer via a printer driver or a scanner driver.

A slot 12 is provided at a front upper-left portion of the recording apparatus 1. Various small-sized memory cards as storage media can be installed to the slot 12. When the predetermined operation is performed on the operation panel 11, the data, which is stored in the small-sized memory card installed to the slot 12, is read. The read data can be displayed on the liquid crystal display of the operation panel 11 as well. Any image, which is selected on the basis of the display, can be recorded on the recording paper by the printer 2.

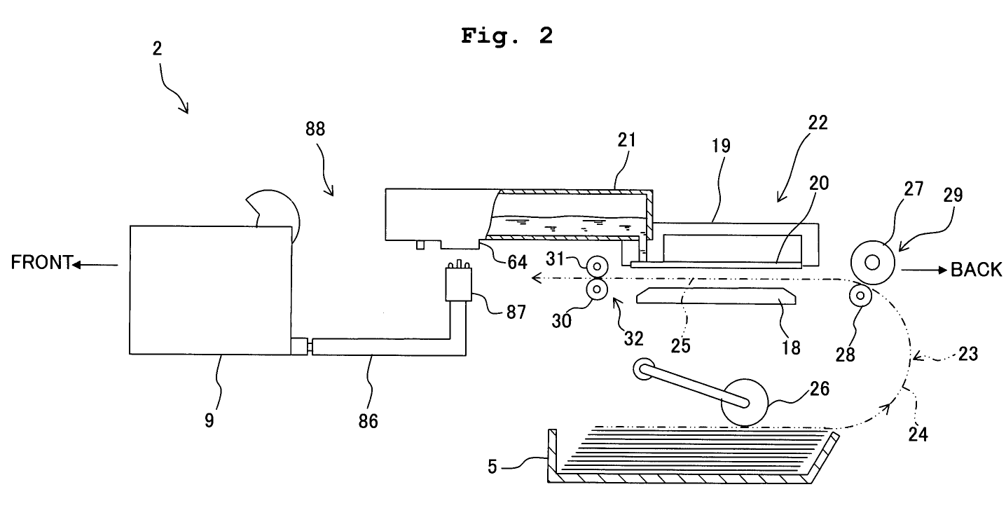

FIG. 2 shows a schematic sectional view illustrating an arrangement of the printer 2. As shown in FIG. 2, the paper feed tray 5 is provided in the vicinity of the bottom of the recording apparatus 1. A platen 18 is provided over the paper feed tray 5. An image-recording unit 22, which includes, for example, a recording head 20 and a sub tank 21 carried on a carriage 19 as described later on, is further provided over the platen 18. A recording paper transport passage 23 is provided to extend from the deep side portion of the paper feed tray 5. The recording paper transport passage 23 is composed of a curved path 24 which is directed upwardly from the deep side portion of the paper feed tray 5 and which is further curved toward the front surface side, and a straight path 25 which extends frontwardly from the terminal end of the curved path 24. The recording paper transport passage 23 is constructed by an outer guide surface and an inner guide surface which are opposed to one another while providing a predetermined spacing distance at portions other than the portion at which the image-recording unit 22 is arranged.

A paper feed roller 26, which supplies the recording paper accommodated in the paper feed tray 5 to the recording paper transport passage 23, is provided just over the paper feed tray 5. A pair of transport rollers 29, which are composed of a transport roller 27 and a pinch roller 28, are provided in the vicinity of the downstream portion of the curved path 24 in the recording paper transport passage 23 so that the recording paper transport passage 23 is interposed by the both rollers 27, 28 from the upper and lower positions. Further, a pair of paper discharge rollers 32, which are composed of a paper discharge roller 30 and a pinch roller 31, are provided in the vicinity of the downstream portion of the straight path 25 in the recording paper transport passage 23 so that the recording paper transport passage 23 is interposed by the both rollers 30, 31 from the upper and lower positions. The recording head 20 and the platen 18 described above are provided so that the straight path 25 is interposed from the upper and lower positions between the pair of transport rollers 29 and the pair of paper discharge rollers 32.

Therefore, the recording paper, which is accommodated in the paper feed tray 5, is supplied to the recording paper transport passage 23 by the paper feed roller 26. Subsequently, the recording paper is transported from the curved path 24 to the straight path 25 on the recording paper transport passage 23 by the pair of transport rollers 29. When the recording paper arrives at the straight path 25, the image is recorded thereon with the inks discharged from the recording head 20. When the recording is completed, then the recording paper is discharged from the straight path 25 by the pair of paper discharge rollers 32, and the recording paper is accommodated in the paper discharge tray 6 (see FIG. 1).

The recording apparatus 1 executes, for example, the ink supplement process for the sub tanks 21 and the maintenance process for the recording head 20 as described later on, in addition to the recording with the image on the recording paper. An ink supplement section 88 is provided in front of the image-recording unit 22 as described later on.

FIG. 3 shows a plan view illustrating main components of the printer 2, which depicts a state in which the image-recording unit 22 is positioned at a predetermined position to perform the ink supplement. As shown in FIG. 3, a pair of guide rails 38, 39, each of which has a flat plate-shaped form having a long size in the left-right direction (direction perpendicular to the transport direction of the recording paper), are arranged over or above the straight path 25 (see FIG. 2) of the recording paper transport passage 23. The guide rails 38, 39 are provided so that the guide rail 38 is positioned at the back of the guide rail 39 while being separated by a predetermined distance in the front-back direction (transport direction of the recording paper). The guide rails 38, 39 are provided in the casing la of the recording apparatus 1 (see FIG. 1), which constitute a part of a frame for supporting the respective constitutive components for constructing the printer 2. The carriage 19, which constitutes the image-recording unit 22, is supported by the guide rails 38, 39 so that the carriage 19 is slidable reciprocatingly in the extending direction (left-right direction) of the guide rails 38, 39.

As shown in FIG. 3, a belt-driving mechanism 40 is arranged on the upper surface of the guide rail 39. The belt-driving mechanism 40 includes an endless annular timing belt 44 which has teeth provided on the inner side and which is tensionally arranged between a driving pulley (not shown) and a driven pulley 43 provided in the vicinity of the both ends in the widthwise direction of the recording paper transport passage 23 respectively. A carriage motor 45 is connected to the shaft of the driving pulley 42. The driving pulley is rotated by inputting the driving force from the carriage motor 45. The timing belt 44 receives the rotation to perform the rounding motion between the driving pulley and the driven pulley 43.

The carriage 19 is secured to the timing belt 44 at the bottom thereof. Therefore, the carriage 19 makes the reciprocating motion in the left and right directions on the guide rails 38, 39 in accordance with the rounding motion of the timing belt 44. The recording head 20 and the sub tanks 21 are carried on the carriage 19 (see FIG. 2). Therefore, the recording head 20 makes the reciprocating motion in the main scanning direction (left-right direction) in accordance with the movement of the carriage 19.

As shown in FIG. 3, the position, which is disposed in the vicinity of the left ends of the guide rails 38, 39 as viewed in a plan view, is the ink supplement position 50. The main tanks 9 are arranged at the ink supplement position 50 in a state of being installed to the main tank-carrying section 8. When the carriage 19, which is movable along the guide rails 38, 39, is moved to the ink supplement position 50 (state shown in FIG. 3), the ink supplement process is executed to perform the ink supplement from the main tanks 9 to the sub tanks 21 as described later on. The position, which is disposed in the vicinity of the right ends of the guide rails 38, 39 as viewed in a plan view, is the maintenance position 51. A maintenance mechanism 55 is arranged at the maintenance position 51. Therefore, when the carriage 19 is moved to the maintenance position 51 (state shown by the two-dot chain lines in FIG. 3), then the recording head 20 is subjected to the purge process by the maintenance mechanism 55, and the maintenance is executed for the ink flow passage.

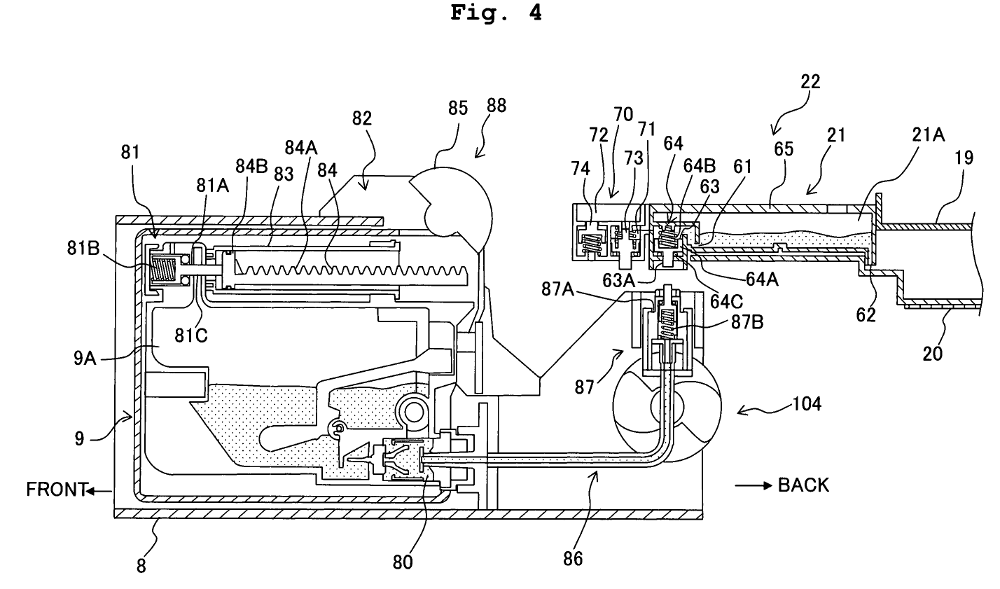

Next, an explanation will be made about the arrangement of the image-recording unit 22 and the main tank 9. FIG. 4 shows a sectional view mainly illustrating the arrangement of the image-recording unit 22 and the main tank 9, which depicts the arrangement as obtained by cutting a part of the printer 2 shown in FIG. 3 along a cutting line IV-IV.

As shown in FIG. 4, the image-recording unit 22 is provided with, for example, the recording head 20 and the sub tanks 21 which are carried on the carriage 19 having the rectangular casing form. The recording head 20 is constructed by stacking a plurality of plates (not shown) which has the ink flow passages (not shown) formed therein. Openings, which are disposed on the downstream side of the ink flow passages, form nozzle holes.

The sub tank 21 has a box-shaped form in which the dimension in the left-right direction is smaller than the dimension in the front-back direction. Five of the sub tanks 21 are prepared in total one by one for each of the colors. As shown in FIG. 4, the sub tank 21 has a sub-ink chamber 21A having a predetermined volume, which has a first communication port 61 provided at a front side portion of the inner bottom, and a second communication port 62 provided at a back side portion of the inner bottom. The sub tank 21 is communicated with the upstream side opening of the ink flow passage possessed by the recording head 20 via the second communication port 62. The ink contained in the sub-ink chamber 21A can be supplied to the recording head 20.

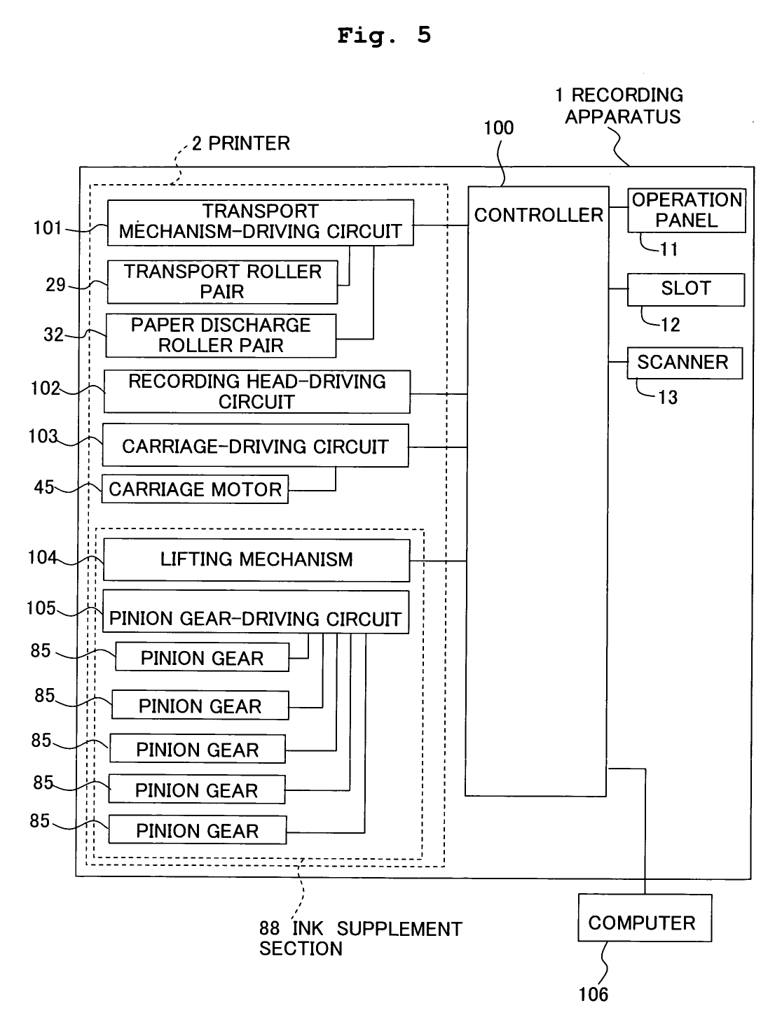

A refill port valve 64, which communicates the sub-ink chamber 21A and the main ink chamber 9A of the main tank 9 during the supplement with the ink, is provided in front of the sub-ink chamber 21A. In particular, a refill chamber 63, which communicates with the sub-ink chamber 21A via the first communication port 61, is provided in front of the first communication port 61. A refill port 63A, which communicates with the outside, is formed at a lower portion of the refill chamber 63. The refill port valve 64 is accommodated in the refill chamber 63. The refill port valve 64 includes a valve plug 64A which is inserted into the refill port 63A and which is movable upwardly and downwardly, a coil spring 64B which urges the valve plug 64A in the direction to close the refill port 63A (in the downward direction as viewed in FIG. 5), and a seal member 64C. The refill port valve 64 closes the refill port 63A by the urging force of the coil spring 64B in a state in which no external force is exerted on the valve plug 64A. On the other hand, when the external force is applied to move the valve plug 64A upwardly (toward the inside of the refill chamber 63), the refill port 63A is opened to communicate the outside and the sub-ink chamber 21A.

Further, a pressure-adjusting section 70 is provided in front of the sub tank 21. The pressure-adjusting section 70 has a negative pressure-adjusting chamber 71 which is communicated with the sub-ink chamber 21A via a passage 65 having a small cross-sectional area and having a labyrinth structure formed on the upper surface of the upper wall of the sub tank 21, and a positive pressure-adjusting chamber 72 which is positioned over or above the negative pressure-adjusting chamber 71. Further, the pressure-adjusting section 70 has a negative pressure-adjusting valve 73 which communicates the outside and the sub-ink chamber 21A via the negative pressure-adjusting chamber 71 during the purge, and a positive pressure-adjusting valve 74 which communicates the outside and the sub-ink chamber 21A via the positive pressure-adjusting chamber 72 and the negative pressure-adjusting chamber 71.

On the other hand, the main tank 9 has a box-shaped form in which the dimension in the left-right direction is smaller than the dimension in the front-back direction as shown in FIG. 3. Five of the main tanks 9 are prepared in total one by one for each of the colors. As shown in FIG. 4, the main tank 9 has a main ink chamber 9A having a predetermined volume. An ink supply port 80, which is communicated with the main ink chamber 9A, is provided in the vicinity of the bottom. A positive pressure-adjusting valve 81 and a pump 82 are provided at upper portions.

The positive pressure-adjusting valve 81 has a valve plug 81A, and a coil spring 81B which urges the valve plug 81A. The positive pressure-adjusting valve 81 maintains the internal pressure of the main ink chamber 9A to be not more than a predetermined positive pressure value. That is, the communication is blocked between the main ink chamber 9A and the outside in a state in which the internal pressure of the main ink chamber 9A is not more than the predetermined positive pressure value, while the main ink chamber 9A and the outside are communicated with each other when the internal pressure exceeds the predetermined positive pressure value. A push rod 81C, which has a long dimension and which is rod-shaped, is provided to extend backwardly toward the pump 82 from the end surface of the valve plug 81A possessed by the positive pressure-adjusting valve 81.

The pump 82 is provided to change the volume of the main ink chamber 9A in order to supplement the sub-ink chamber 21A with the ink and recover the ink from the sub-ink chamber 21A as described later on. The pump 82 is provided with a cylinder 83, a piston 84 which has a long dimension, which is rod-shaped, and which is accommodated in the cylinder 83, and a pinion gear 85 which drives the piston 84. In particular, the piston 84, which constitutes the pump 82, is provided with a rack gear 84A which is formed at an upper portion thereof, and a piston crown 84B which is provided at the forward end.

The rack gear 84A is meshed with the pinion gear 85. The piston 84 makes the reciprocating movement in the front-back direction in the cylinder 83 in accordance with the rotary driving of the pinion gear 85. During this process, the piston crown 84B makes the reciprocating movement while making the sliding contact with the inner wall surface of the cylinder 83 in the air-tight manner. A hole having a small diameter is formed through the wall disposed on one side of the cylinder 83. The push rod 81C, which is possessed by the positive pressure-adjusting valve 81, penetrates through the hole to extend to the interior of the cylinder 83. Therefore, when the piston 84 is moved frontwardly, then the piston crown 84B pushes and moves the valve plug 81A frontwardly by the aid of the push rod 81C, and the positive pressure-adjusting valve 81 is opened.

A joint valve 87, which is jointed to the refill port valve 64 provided for the sub tank 21, is attached via a tube 86 arranged outside the main tank 9 to the ink supply port 80 provided in the vicinity of the bottom of the main tank 9. The joint valve 87 includes, for example, a valve plug 87A which is movable in the vertical direction, and a coil spring 87B which urges the valve plug 87A upwardly. The joint valve 87 is closed by the urging force of the coil spring 87B when no external force is exerted on the valve plug 87A. When the external force directed in the downward direction is exerted on the valve plug 87A, and the valve plug 87A is moved in the downward direction against the urging force of the coil spring 87B, then the main ink chamber 9A communicates with the outside via the tube 86 and the joint valve 87.

The joint valve 87 as described above is moved upwardly and downwardly by a lifting mechanism 104. Therefore, when the joint valve 87 is moved upwardly by the lifting mechanism 104 when the image-recording unit 22 is positioned at the ink supplement position 50, then the valve plug 87A of the joint valve 87 and the valve plug 64A of the refill port valve 64 are mutually pushed and moved, and the both valves 64, 87 are opened. As a result, the main ink chamber 9A of the main tank 9 and the sub-ink chamber 21A of the sub tank 21 communicate with each other via the valves 64, 87.

In this embodiment, the ink supplement section 88 includes, for example, the main tank 9 provided with, for example, the main ink chamber 9A and the pump 82, the tube 86, the joint valve 87, the lifting mechanism 104, the pinion gear 85 meshed with the pump 82, and the pinion gear-driving circuit 105 (see FIG. 5) for driving the pinion gear 85 included in the arrangement described above.

FIG. 5 shows a block diagram illustrating the function possessed by the recording apparatus 1 constructed as described above. As shown in FIG. 5, the recording apparatus 1 is provided with the controller 100. The controller 100 includes, for example, unillustrated CPU (Central Processing Unit), RAM (Random-Access Memory), ROM (Read-Only Memory), and an input/output interface. The scanner 3, the operation panel 11, and the slot 12 (see FIG. 1), which have been already explained, are connected to the controller 100. Those further connected to the controller 100 include, for example, the transport mechanism-driving circuit 101, the recording head-driving circuit 102, the carriage-driving circuit 103, the lifting mechanism 104, and the pinion gear-driving circuit 105. These components execute the operation as explained below on the basis of the instruction signal supplied from the controller 100.

The transport mechanism-driving circuit 101 drives the unillustrated motor to rotate the transport roller pair 29 and the paper discharge roller pair 32 (see FIG. 2 as well) which are connected to the output shaft of the motor so that the recording paper is transported along the recording paper transport passage 23.

The recording head-driving circuit 102 makes the recording head 20 discharge the ink toward the recording paper at the timing and in the ink amount determined on the basis of the signal supplied from the controller 100. The recording head-driving circuit 102 is capable of changing the image quality mode of the image to be recorded on the recording paper on the basis of the signal supplied from the controller 100. The recording head-driving circuit 102 is capable of discharging the ink in accordance with one mode selected from the draft mode in which the low image quality is permitted, the fine mode in which the high image quality is required, and the normal mode in which the intermediate image quality between those of the both modes is required. The controller 100 calculates the cumulative value of the discharge amount of each of the inks on the basis of the instruction signal as described above outputted to the recording head-driving circuit 102 so that the residual amount of the ink contained in the sub tank 21 is calculated. The cumulative value of the ink discharge amount may be appropriately accumulated, for example, in RAM of the controller 100 for each of the ink colors.

The carriage-driving circuit 103 is connected to the carriage motor 45. The carriage 19 is moved in the left-right direction by driving and rotating the carriage motor 45. The lifting mechanism 104 is driven on the basis of the signal supplied from the controller 100 to move the joint valve 87 upwardly and downwardly. The pinion gear-driving circuit 105 drives the unillustrated motor to rotate the pinion gear 85 connected to the output shaft of the motor so that the pump 82 is driven to change the volume of the main ink chamber 9A.

Further, the controller 100 is connected to the personal computer (PC, hereinafter abbreviated as “computer”) 106 as the external information device. The controller 100 outputs the instruction signal on the basis of the signal supplied from the computer 106 or the operation panel 11.

Next, an explanation will be made about the operation of the recording apparatus 1 as described above.

At first, an explanation will be made about the ink supplement process for performing the ink supplement from the main tank 9 to the sub tank 21. When the residual amount of the ink contained in the sub-ink chamber 21A of the sub tank 21 is decreased to be not more than the predetermined threshold value, the recording apparatus 1 executes the ink supplement process by driving the ink supplement section 88 by the aid of the controller 100. The recording apparatus 1 according to this embodiment adopts the station supply system. When the process is executed, the series of operation, which will be explained in detail below, is performed such that the residual ink is once recovered from the sub tank 21 to the main tank 9, and then the ink supplement is performed from the main tank 9 to the sub tank 21.

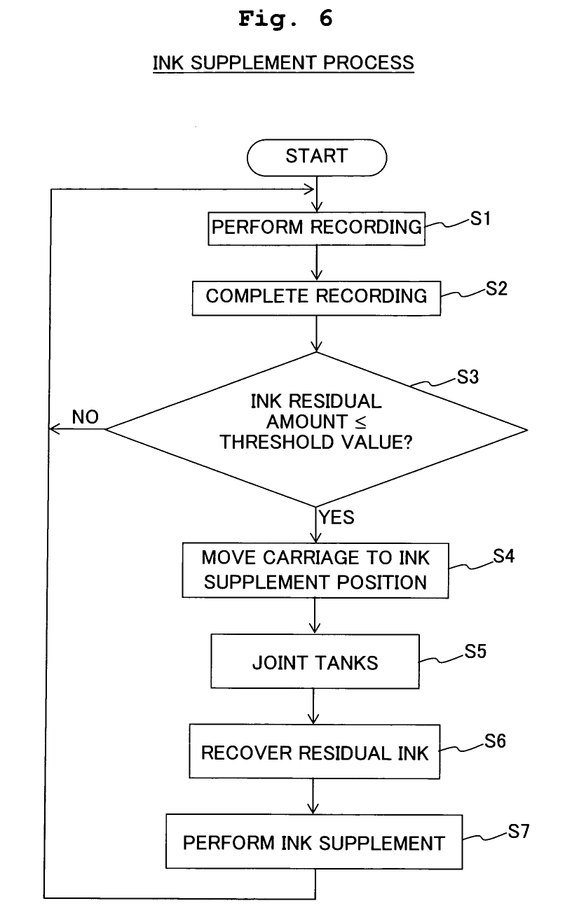

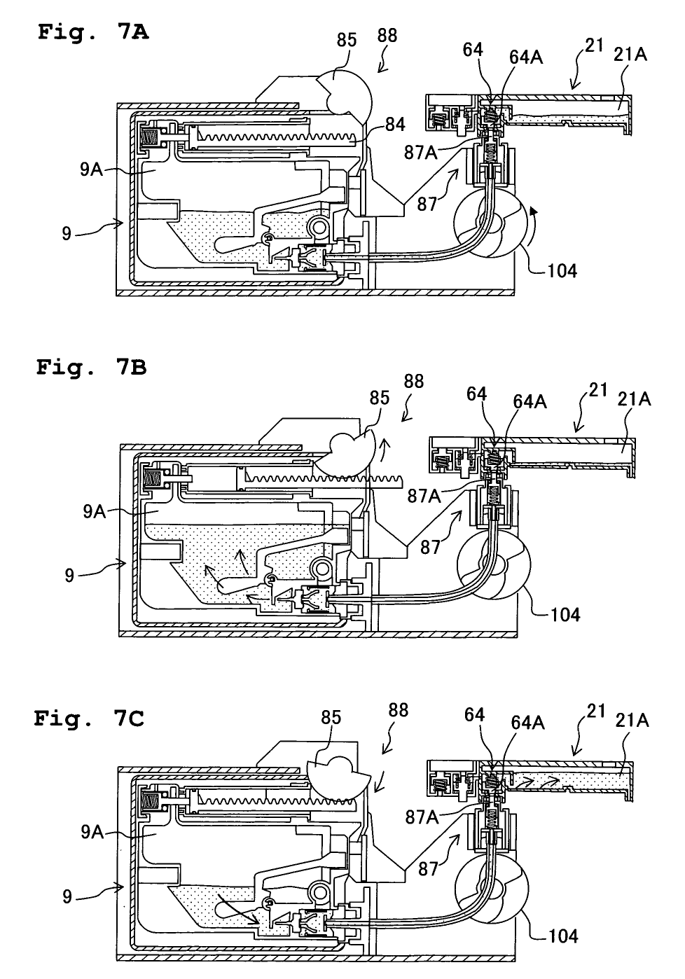

FIG. 6 shows a flow chart illustrating the operation of the recording apparatus 1 in relation to the ink supplement process. FIG. 7 schematically shows the state change of the image-recording unit 22 and the ink supplement section 88 during the ink supplement process, wherein FIG. 7A shows a state in which the main tank 9 and the sub tank 21 are communicated with each other before the ink supplement, FIG. 7B shows a state in which the ink is once recovered from the sub tank 21, and FIG. 7C shows a state in which the sub tank 21 is supplemented with the ink. The state, in which the main tank 9 and the sub tank 21 are not communicated with each other before the ink supplement, is shown in FIG. 4 having been already referred to.

As shown in FIG. 6, the recording apparatus 1 performs the recording of the image on the recording paper (Step S1). When the recording is completed for one sheet of the paper (Step S2), it is judged whether or not the residual amount of the ink contained in the sub tank 21 is not more than the predetermined threshold value (this judging process will be described later on) (Step S3). If the ink residual amount has a value which exceeds the threshold value (Step S3: NO), the routine returns to Step S1 to perform the recording on the next recording paper. If it is judged that the ink residual amount is not more than the threshold value (Step S3: YES), the carriage motor 45 (see FIG. 5) is driven to position the carriage 19 at the ink supplement position 50 (Step S4). In this situation, the main tank 9 and the sub tank 21 are in the positional relationship shown in FIG. 4. Subsequently, the ink supplement section 88 is driven to joint the main tank 9 and the sub tank 21. That is, the lifting mechanism 104 is driven to move the joint valve 87 upwardly, and the sub-ink chamber 21A and the main ink chamber 9A are communicated with each other via the joint valve 87 and the refill port valve 64 as shown in FIG. 7A (Step S5).

When the both ink chambers 9A, 21A are communicated with each other, then the pinion gear 85 is rotated to move the piston 84 backwardly, and the negative pressure is provided in the main ink chamber 9A. Accordingly, as shown in FIG. 7B, the residual ink contained in the sub-ink chamber 21A is once recovered to the main ink chamber 9A (Step S6). After the completion of the recovery process, the pinion gear 85 is reversely rotated to move the piston 84 frontwardly so that the positive pressure is provided in the main ink chamber 9A. Accordingly, as shown in FIG. 7C, the ink supplement is performed from the main ink chamber 9A to the sub-ink chamber 21A (Step S7). When the supplement with the ink is completed by rotating the pinion gear 85 by a predetermined angle (number of revolutions), then the routine returns to Step S1 to restart the recording on the next recording paper.

In this way, in the ink supplement process of the recording apparatus 1 according to this embodiment, the vacant volume in the sub-ink chamber 21A is always substantially constant upon the supplement with the ink from the main ink chamber 9A, because the residual ink contained in the sub-ink chamber 21A is once recovered. Therefore, the ink supplement can be performed accurately to arrive at the maximum volume of the sub-ink chamber 21A without providing any sensor for detecting the ink amount for the sub tank 21.

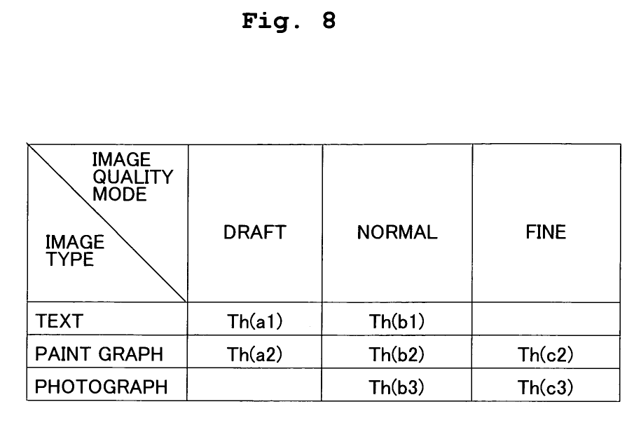

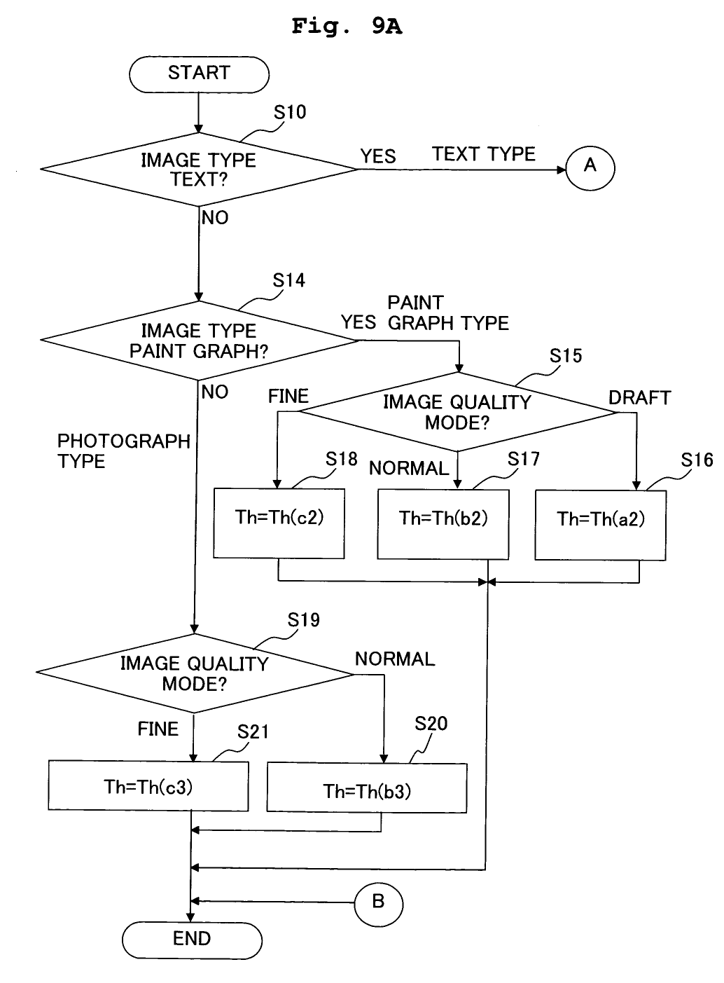

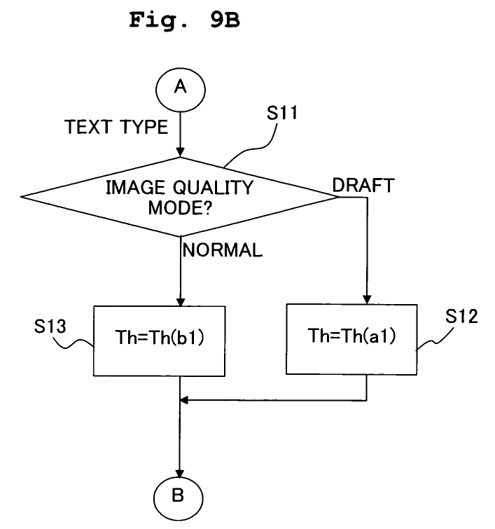

In the case of the recording apparatus 1 according to the embodiment of the present invention, the threshold value, which relates to the ink residual amount referred to in the judgment in Step S3 shown in FIG. 6 described above, is changeable. The threshold value is appropriately established on the basis of the image type and the image quality mode. FIG. 8 shows a table illustrating the relationship between the image type, the image quality mode, and the threshold value (first threshold value) preset in the recording apparatus 1. FIGS. 9A and 9B show a flow chart illustrating the process procedure for determining the threshold value to be performed by the controller 100.

As shown in FIG. 8, the three types are defined or preset as the image types in ROM of the controller 100. There are the text type in which letters and symbols are mainly recorded, the paint graph type for performing a record of an image including an area densely recorded with the ink without any space, the photograph type for recording the photograph image. The three types of the image quality modes are defined or preset as well. As having been already explained, there are the draft mode in which the low image quality is permitted, the fine mode in which the high image quality is required, and the normal mode in which the intermediate image quality between those of the both modes is required. In this case, x of Th(xn) shown in FIG. 8 represents the image quality mode, wherein x=a represents the draft mode, x=b represents the normal mode, and x=c represents the fine mode. On the other hand, n of Th(xn) represents the image type, wherein n=1 represents the text type, n=2 represents the paint graph type, and n=3 represents the photograph type. Th(xn) means the ink amount required, for example, when the recording is performed with the designated image type and the designated image quality mode on one sheet of the recording paper having the A4 size. In the text type, the threshold values of Th(a1) and Th(b1) (Th(a1)<Th(b1)) are preset in this order for the draft mode and the normal mode. In the paint graph type, the threshold values are preset for all of the image quality modes, wherein the threshold values of Th(a2), Th(b2), and Th(c2) (Th(a2)<Th(b2)<Th(c2)) are preset in this order for the draft mode, the normal mode, and the fine mode. In the photograph type, the threshold values of Th(b3) and Th(c3) (Th(b3)<Th(c3)) are preset in this order for the normal mode and the fine mode. The setting shown in the table of FIG. 8 may be made for every color of the ink and/or every size of the recording paper. Alternatively, the setting may be made as a calculating formula or expression without being limited to the table form.

The amount of use of the ink is increased in an order of “text type<photograph type<paint graph type” in the same image quality mode. Therefore, with reference to FIG. 8 as well, there is given Th(b1)<Th(b3)<Th(b2) when the comparison is made for the threshold values between the respective image types in the normal mode. As for the various combinations of the image types and the image quality modes, the amount of consumption of the ink is the largest in the image recording in the fine mode of the paint graph type. Therefore, the threshold value Th(c2) in this case has the largest value.

When the controller 100 receives the recording instruction in accordance with the signal fed from the computer 106 or the signal based on the operation of the operation panel 11 by the user, the controller 100 judges whether or not the type of the image to be recorded next is the text on the basis of the recording instruction as shown in FIG. 9A (Step S10). If it is judged that the image type is the text (Step S10: YES), it is judged whether the image quality mode is either the draft or the normal (Step S11). If the image quality mode is the draft as a result of the judgment, Th(a1) is obtained as the threshold value Th (Step S12). If the image quality mode is the normal, Th(b1) is obtained as the threshold value Th (Step S13). The threshold value-determining process comes to an end.

If it is judged in Step S10 that the image type is not the text (Step S10: NO), it is judged whether or not the image type is the paint graph (Step S14). If it is judged that the image type is the paint graph (Step S14: YES), it is judged whether the image quality mode is any one of the draft, the normal, and the fine (Step S15). If the image quality mode is the draft as a result of the judgment, Th(a2) is obtained as the threshold value Th (Step S16). If the image quality mode is the normal, Th(b2) is obtained as the threshold value Th (Step S17). If the image quality mode is the fine, Th(c2) is obtained as the threshold value Th (Step S18). The threshold value-determining process comes to an end.

If it is judged in Step S14 that the image type is not the paint graph (Step S14: NO), then it is definitely decided that the image type is the remaining photograph type, and it is judged whether the image quality mode is either the normal or the fine (Step S19). If the image quality mode is the normal as a result of the judgment, Th(b3) is obtained as the threshold value Th (Step S20). If the image quality mode is the fine, Th(c3) is obtained as the threshold value Th (Step S21). The threshold value-determining process comes to an end.

As described above, the recording apparatus 1 appropriately determines the threshold value in relation to the ink residual amount based on the type and the image quality mode of the image to be recorded next. As explained with reference to FIG. 6, the determined threshold value and the ink residual amount are compared with each other to judge whether or not the ink supplement process for the sub tank 21 is executed (see Step S3 shown in FIG. 6). Therefore, it is possible to reduce the number of operations of the ink supplement by suppressing the execution of the ink supplement in the state in which the surplus ink is present, while avoiding the exhaustion of the ink during the recording operation on one sheet of the recording paper.

When the copy process, in which a same image is recorded on a plurality of sheets, is executed, the recording apparatus 1 can determine the threshold value (second threshold value) as the judgment basis to judge whether or not the ink supplement process (see FIG. 6) is executed prior to the recording on the second sheet and the thereafter, based on the ink amount used in the recording on the first sheet of the recording paper. An explanation will be made below about the operation in the copy process.

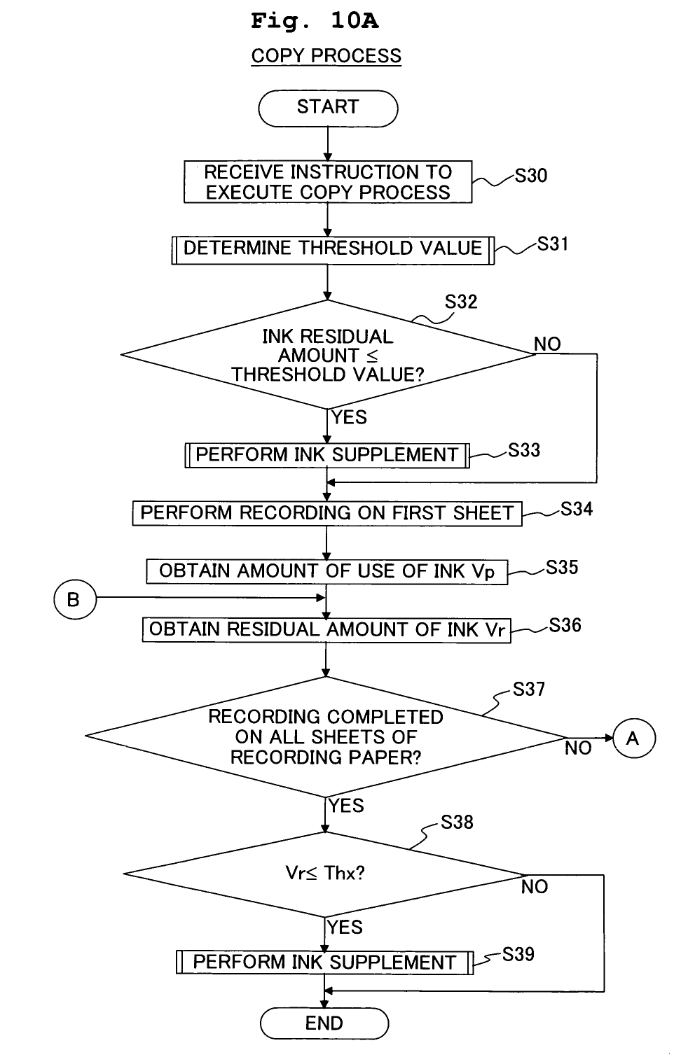

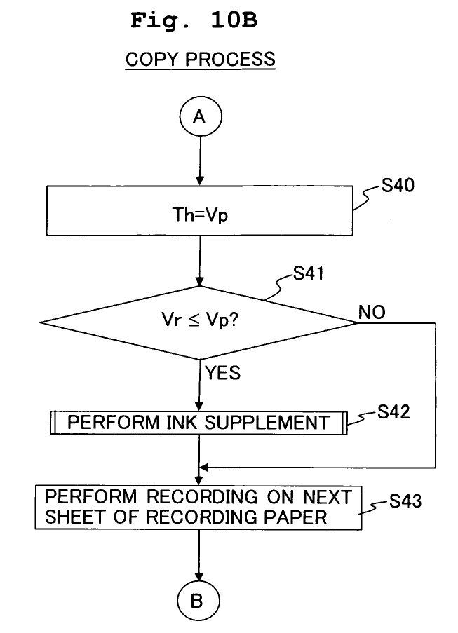

FIGS. 10A and 10B show a flow chart illustrating the copy process procedure. As shown in FIG. 10A, when the controller 100 receives the instruction to execute the copy process in accordance with the signal fed from the computer 106 or the signal based on the operation of the operation panel 11 by the user (Step S30), the controller 100 determines the threshold value (first threshold value) prior to the recording on the first sheet of the recording paper (Step S31). In this case, the threshold value is determined in accordance with the procedure explained with reference to FIGS. 9A and 9B. It is judged whether or not the ink residual amount of the sub tank 21 is not more than the threshold value (Step S32). If the ink residual amount is not more than the threshold value, then the ink supplement is performed (Step S33), and then the recording is performed on the first sheet of the recording paper (Step S34). If the ink residual amount is more than the threshold value, the recording is performed on the first sheet of the recording paper (Step S34) without performing the ink supplement. The amount of use of the ink Vp, which is used for the recording on the first sheet of the recording paper, is calculated and obtained (Step S35).

Subsequently, the residual amount of the ink Vr of the sub tank 21 is obtained based on the amount of use of the ink Vp (Step S36), and it is judged whether or not the recording is completed on the total number of the sheets of the recording paper (Step S37). If it is judged that the recording is completed (Step S37: YES), it is judged whether or not the ink residual amount Vr is not more than the predetermined threshold value Thx (Step S38). If it is judged that the ink residual amount Vr is not more than the threshold value Thx (Step S38: YES), then the ink supplement process as shown in Steps S4 to S7 in FIG. 6 is executed (Step S39), and the copy process is completed. If it is judged that the ink residual amount Vr is more than the threshold value Thx (Step S38: NO), the copy process is completed without performing the ink supplement process. In the judgment in Step S38, it is unclear in this situation what kind of the recording is to be performed next. Therefore, for example, the amount of use of the ink, which is to be used when the recording is performed in the fine mode on the entire surface of one sheet of the recording paper, can be regarded as the threshold value Thx. Alternatively, it is also allowable to adopt, as the threshold value Thx, any one of the threshold values Th(a1), Th(b1), Th(a2), Th(b2), Th(c2), Th(b3), and Th(c3) shown in FIG. 8.

On the other hand, if it is judged in Step S37 that the recording is uncompleted for the total number of the sheets (Step S37: NO), the amount of use of the ink Vp used for the recording on the first sheet of the recording paper is set as the threshold value (second threshold value) Th as the basis for judging whether or not the ink supplement is required (Step S40). When the first threshold value and the second threshold value are compared with each other, a relationship of “first threshold value>second threshold value” is given.

It is judged whether or not the ink residual amount Vr obtained in Step S36 is not more than the threshold value Th (=Vp) (Step S41). If it is judged that the ink residual amount Vr is not more than the threshold value Th (=Vp) as a result of the judgment (Step S41: YES), then the ink supplement process described in Steps S4 to S7 shown in FIG. 6 is executed (Step S42), and then the recording is executed on the second sheet of the recording paper (Step S43). If it is judged that the ink residual amount Vr is greater than the threshold value Th (=Vp) (Step S41: NO), the recording is executed on the second sheet of the recording paper without performing the ink supplement process (Step S43). Further, the processes in Step S36 and the followings are repeated again.

As described above, the recording apparatus 1 determines the threshold value Th to be used as the judgment basis to judge whether or not the ink supplement process is executed when the recording is performed on the second sheet of the recording paper, based on the amount of use of the ink Vp in the recording on the first sheet of the recording paper. Therefore, the threshold value can be preset more accurately. It is possible to reduce the number of operations of the ink supplement, while suppressing the execution of the ink supplement in the state in which the surplus ink is present.

In the process procedure explained with reference to FIGS. 10A and 10B, the threshold value is determined in accordance with the procedure shown in FIGS. 10A and 10B prior to the recording on the first sheet of the recording paper, and it is judged whether or not the ink supplement process is required based on the threshold value (Steps S31 to S33). However, there is no limitation thereto. For example, the ink supplement process may be uniformly executed so that the ink residual amount in the sub tank 21 is maximized prior to the recording on the first sheet of the recording paper. When it is estimated that a predetermined amount of the ink remains in the sub tank 21 after the ink recovery operation during the ink supplement process, the second threshold value Th is strictly the value obtained by adding Vp to the amount of estimation.

The explanation has been made with reference to FIGS. 10A and 10B about the process procedure to be adopted when the image, which is the same as the image to be recorded on the first sheet of the recording paper, is also recorded on the second sheet of the recording paper and the thereafter. However, in the case of the copy process in which a plurality of sets of a series of document recorded on a plurality of sheets of the recording paper are prepared, the following procedure is appropriately adopted.

That is, the processes of Steps S31 to S35 are executed on the respective sheets of the recording paper until the recording is completed on all of the sheets of the recording paper of the first set. Accordingly, it is judged whether or not the ink supplement is required prior to the recording on the respective sheets of the recording paper, and the amounts of use of the ink in the recording on the respective sheets of the recording paper are individually obtained. In the processes in Step S36 and the followings, when the recording is performed on the sheets of the recording paper of the second set, the threshold values for the respective sheets of the recording paper are individually determined based on the amounts of use of the ink corresponding to the respective sheets of the recording paper of the first set having been already obtained. It is judged whether or not the ink supplement process is required prior to the recording for each of the sheets of the recording paper based on the threshold values.

According to the process as described above is executed, it is possible to make the judgment whether or not the ink supplement process is required prior to the recording on the respective sheets of the recording paper based on the threshold values obtained at the higher accuracy, even in the case of the copy process in which a plurality of sets of a series of document recorded on a plurality of sheets of the recording paper are prepared.

As shown in FIG. 1, the recording apparatus 1 according to the embodiment of the present invention is provided with the scanner 3. Therefore, the image scanned by the scanner 3 can be recorded on the recording paper, and it is also possible to execute the copy process in which the image is recorded on a plurality of sheets of the recording paper. Also in this case, the threshold value-determining process shown in FIGS. 9A and 9B is performed prior to the recording on the recording paper. If necessary, the ink supplement process shown in Steps S4 to S7 in FIG. 6 is executed.

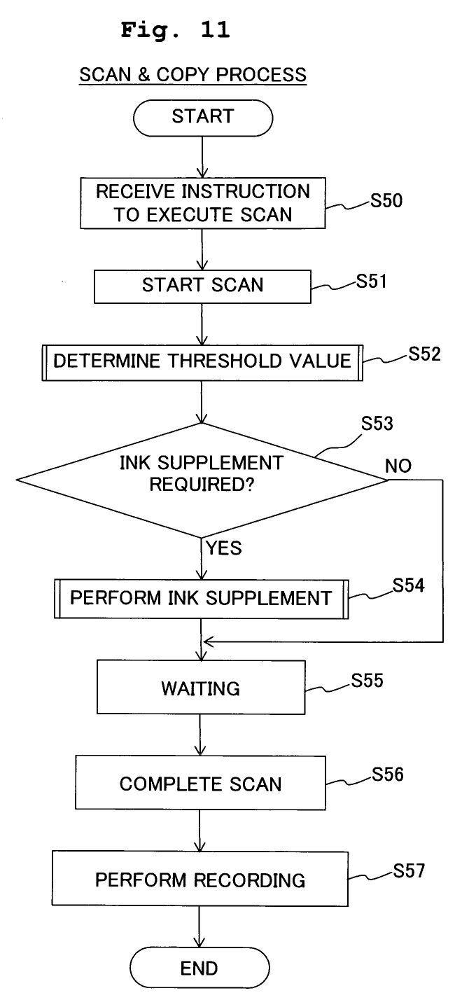

FIG. 11 shows a flow chart illustrating the execution timing for the ink supplement process in the copy process for recording the scanned image on a plurality of sheets of the recording paper. As shown in FIG. 11, when the controller 100 receives the instruction to execute the scan on the basis of the signal fed from the computer 106 or the signal from the operation panel 11 in accordance with the operation by the user (Step S50), then after the start of the scan (Step S51), the threshold value is determined in accordance with the procedure explained with reference to FIGS. 9A and 9B (Step S52), and it is judged whether or not the ink supplement process is required based on the threshold value (Step S53). If it is judged that the ink supplement process is required (Step S53: YES), the ink supplement process is executed (Step S54) in accordance with the procedure explained in Steps S4 to S7 shown in FIG. 6. After that, the routine waits until the completion of the scan (Step S55).

Usually, a relatively long period of time is required until the image, which is recorded on one sheet of the recording paper, is completely scanned. Therefore, the processes of Steps S52 to S54 are completed during the scan. Accordingly, if the ink supplement process of Step S54 is completed and if it is judged in Step S53 that the ink supplement process is unnecessary (Step S53: NO), then the routine waits until the completion of the scan (Step S55). When the scan is completed (Step S56), the processes of Step S34 and the followings are executed as shown in FIGS. 10A and 10B to record the image on a plurality of sheets of the recording paper (Step S57). When the scanned image is recorded on only one sheet of the recording paper, then the scanned image may be recorded on one sheet of the recording paper after the scan is completed in the procedure shown in FIG. 11 (Step S56), and the series of the processes may be completed.

When the ink supplement process is executed prior to the recording on the first sheet of the recording paper at the timing as described above, since the ink supplement process required can be completed during the scan which takes a relatively long period of time, it is efficient.

As having been already explained, according to the recording apparatus 1 as described above, it is possible to reduce the recording waiting time by suppressing the frequent occurrence of the ink supplement operation, while avoiding the discontinuity of the recording operation which would be otherwise caused by the ink supplement. Further, for example, when the recording is performed on the first sheet of the recording paper, the threshold value is determined based on the image type and the image quality mode, and the actual ink amount, which is necessary for the recording, is not calculated. Therefore, it is possible to suppress the increase in the cost which would be otherwise caused by the large capacity of the internal memory. Further, it is possible to realize the reduction of the recording waiting time owing to the reduction of the calculation time.

The present invention has been explained above on the basis of the embodiment in which the present invention is applied to the recording apparatus based on the station supply system. However, the present invention is not limited thereto. The present invention is applicable to any recording apparatus of the type wherein the sub tank, which is movable together with the recording head, is supplemented with the ink at a predetermined timing, for example, even in the case of the recording apparatus based on the so-called tube system (recording apparatus of the type in which the main tank and the sub tank are always connected to one another via the tube).

What is claimed is:

1. A recording apparatus comprising:
a recording head which discharges an ink onto a recording medium to form an image thereon;
a sub tank which is movable together with the recording head and which stores the ink to be supplied to the recording head;
an ink supplement section which supplements the sub tank with the ink; and
a controller which controls the ink supplement section,
wherein the controller controls the ink supplement section to supplement the sub tank with the ink when a residual-ink amount of the ink contained in the sub tank is not more than a threshold value, and the controller is capable of changing the threshold value.

2. The recording apparatus according to claim 1, wherein the controller is capable of changing the threshold value based on an image type of the image to be formed on the recording medium.

3. The recording apparatus according to claim 2, wherein the image type includes a text type for mainly recording letters and symbols, a paint graph type for performing record of an image including an area densely recorded with the ink without leaving any space, and a photograph type for recording a photograph image.

4. The recording apparatus according to claim 3, wherein the threshold value is greater in an order of the paint graph type, the photograph type, and the text type.

5. The recording apparatus according to claim 1, wherein the controller is capable of changing the threshold value based on an image quality mode of the image to be formed on the recording medium.

6. The recording apparatus according to claim 1, wherein when a same image is recorded on a plurality of sheets of the recording medium respectively, the controller determines, based on an ink amount used in recording on a first sheet among the plurality of sheets of the recording medium, a threshold value for recording on a second sheet of the recording medium and thereafter.

7. The recording apparatus according to claim 6, wherein when the same image is recorded on the plurality of sheets of the recording medium respectively, the controller controls,before performing recording on the first sheet of the recording medium, the ink supplement section to supplement the sub tank with the ink until the residual-ink amount in the sub tank is maximized.

8. The recording apparatus according to claim 1, wherein when the same image is recorded on a plurality of sheets of the recording medium respectively and when the residual-ink amount in the sub tank is not more than the threshold value before performing recording on a first sheet of the recording medium, the controller controls the ink supplement section to supplement the sub tank with the ink; and after completing the recording on the first sheet of the recording medium, the controller calculates a second threshold value based on an ink-amount of the ink used for the recording of the first sheet; and determines the second threshold value as a new threshold value for recording on a second sheet of the recording medium and thereafter.

9. The recording apparatus according to claim 8, wherein the controller determines the threshold value depending on at least the image type.

10. The recording apparatus according to claim 8, wherein the threshold value is greater than the value calculated as the second threshold value.

11. The recording apparatus according to claim 1, further comprising a scanner which reads an image recorded on the recording medium, wherein when the image which is read by the scanner is to be recorded on the recording medium and when the sub tank is supplemented with the ink, the controller controls the ink supplement section to supplement the sub tank with the ink during a period in which the scanner reads the image.

12. The recording apparatus according to claim 6, further comprising a scanner which reads an image recorded on a recording medium, wherein when the image which is read by the scanner is to be recorded on each of the plurality of sheets of the recording medium and when the sub tank is to be supplemented with the ink prior to the recording on the first sheet of the recording medium, the controller controls the ink supplement section to supplement the sub tank with the ink during a period in which the scanner reads the image.

13. The recording apparatus according to claim 1, wherein upon supplementing the ink to the sub tank, the controller controls the ink supplement section to communicate the ink supplement section with the sub tank and then to recover the residual ink in the sub tank to the ink supplement section, and causes the ink to be supplemented from the ink supplement section to the sub tank.

14. A recording method for using a recording apparatus provided with a recording head which discharges an ink onto a recording medium to form an image, a sub tank which is movable together with the recording head and which stores the ink to be supplied to the recording head, and an ink supplement section which supplies the ink to the sub tank, the recording method comprising:
receiving a recording instruction;
determining a threshold value based on the recording instruction;
detecting a residual-ink amount of the ink contained in the sub tank;
recovering the ink contained in the sub tank to the ink supplement section when the residual-ink amount in the sub tank is not more than the threshold value;
supplementing the sub tank with the ink from the ink supplement section until the residual-ink amount in the sub tank is greater than the threshold value; and
recording the image by discharging the ink supplemented in the sub tank.

15. The recording method according to claim 14, wherein the threshold value is an amount of the ink required for recording on one sheet of the recording medium.

16. The recording method according to claim 15, wherein when the residual-ink amount in the sub tank is not more than the threshold value, then the ink contained in the sub tank is recovered to the ink supplement section, and the sub tank is thereafter supplemented with the ink from the ink supplement section to be fully filled with the ink.

17. The recording method according to claim 16, wherein when the residual-ink amount in the sub tank is greater than the threshold value, the image is recorded based on the recording instruction.

18. The recording method according to claim 15, wherein the recording instruction includes an information that including a type of the image to be recorded is a text type for mainly recording letters and symbols, a paint graph type for performing a record of an image including an area densely recorded with the ink without leaving any space, or a photograph type for recording a photograph image; and the threshold value is determined based on the information about the type of the image included in the recording instruction.

19. The recording method according to claim 18, wherein the recording instruction further includes another image-quality information about an image quality mode of the image to be recorded; and the threshold value is determined based on the information about the image quality mode included in the recording instruction.
